(19) United States
(12) Patent Application Publication
(10) Pub. No.: US 2018/0233035 A1
(43) Pub. Date: Aug. 16, 2018

(54) METHOD AND FILTER FOR FLOATING CAR DATA SOURCES

(71) Applicant: NEC Europe Ltd., Heidelberg (DE)

(72) Inventors: Luis Moreira-Matias, Heidelberg (DE); Vitor Cerqueira, Feitosa (PT); Jihed Khiari, Heidelberg (DE)

(21) Appl. No.: 15/429,201

(22) Filed: Feb. 10, 2017

(51) Int. Cl. G08G 1/01; G06F 17/30; G06N 99/00

(52) U.S. Cl. CPC G08G 1/0125; G06N 99/005; G06F 17/30539; G08G 1/0112

(57) ABSTRACT

A method of filtering Floating Car Data (FCD) sources includes receiving data from the FCD sources. A plurality of indicators are computed for each of the FCD sources from the data received from the FCD sources. The indicators include at least one indicator that indicates a veracity of the data and at least one indicator that indicates a value of the data. A unified quality indicator is computed for each of the FCD sources from the respective indicators. The unified quality indicators are compared to a predetermined threshold. The data received from the FCD sources is stored excluding, based on the comparison, the data received from at least one of the FCD sources.

### FIELD

The invention relates to a filter for Floating Car Data (FCD) sources and to a method for filtering FCD. The invention also relates to a Traffic Management Center (TMC) and to a method of deploying corrective traffic control actions (CTCA) in a traffic network.

### BACKGROUND

Currently, there are multiple providers of raw Global Positioning System (GPS) measurements, ranging from public transport vehicles to individual pedestrians through their private smartphones. Typically, such measurements, when made on-board a given road vehicle, are known as FCD. Such information empowers Intelligent Transportation Systems (ITS), such as those managed by a TMC, by enabling the automatic extraction of valuable mobility information through distinct data mining processes. Successful examples of these applications range from car sharing, mass transit and taxis.

FCD denotes the type of data produced and/or broadcast by mobile vehicles with respect to their spatial location. Many such datasets are even available on open repositories (e.g. Nanjing Taxi Fleet). Typically, the vehicles have GPS-enabled devices connected to communications network and periodically send their positions using GPS coordinates to a TMC. However, FCD can cover multiple sources of information and has application across different industries. An advanced TMC, which is responsible for the control of their transportation networks (e.g., either road infrastructure or coordinated transport fleets, such as transit or taxis), relies heavily on this information. Data-driven Intelligent Transportation Systems (ITS) are taking advantage of such data to discover useful mobility patterns with applications to transit planning and traffic control in general, among others. As discussed, for example, in Moreira-Matias, Luis, et al., “On predicting the taxi-passenger demand: A real-time approach,” Portuguese Conference on Artificial Intelligence, Springer Berlin Heidelberg (2013) and in Jenelius, Erik, et al., “Travel time estimation for urban road networks using low frequency probe vehicle data,” Transportation Research Part B: Methodological, Volume 53, Pages 64-81, ISSN 0191-261 (July 2013), FCD serves as a backbone to advanced visualization framework and other statistical inference/machine learning frameworks capable of estimating the current and/or the future traffic status with respect to the links. FIG. 1A shows a typical visualization, from GOOGLEMAPS, of traffic status in real-time inferred from FCD sources in a TMC. This information can be used to deploy (manually or automatically) CTCA in the network (such as traffic re-routing or dynamic speed control) to mitigate the severity of road incidents (e.g. queue length) or, ultimately, to even avoid such incidents from happening. FIG. 1B illustrates different possible CTCA which can be deployed to mitigate possible road congestions. Despite its usefulness, hitherto little attention has been paid to evaluate the relevance of the data broadcasted by FCD sources

U.S. Pat. Nos. 7,706,965 and 7,912,628, and U.S. Patent Application Publication No. 2007/0208493 each describe a system to estimate/predict traffic status based on multiple data sources. These patents are focused on Road Traffic Sensors (RTS), which are typically fixed sensors that are able to collect and/or broadcast aggregated measures about the traffic status on a given road segment such as traffic flow (number of vehicles that traversed those segments per period of time) or occupancy (percentage of time that at least one vehicle were occupying those segment per period of time). An illustration of the data typically produced by these sensors over the course of a day is depicted in FIG. 2, where the upper line depicts an occupancy per unit of time and the lower line depicts flow counts per unit of time. This type of data does not identify singular vehicles nor their trajectories (e.g. origin, destination, speeds), but simply provides aggregated measures with respect to a given road segment.

However, FCD differs radically from RTS data both in nature, size and type of measurements. An illustration of FCD typically produced by a sensor-equipped vehicle is depicted in FIG. 3, with GPS latitude and longitude (WGS84 format), vehicle status and a Julian timestamp. Additionally, the type of analysis that RTS and FCD allow for is radically different. RTS is much more limited in terms of accuracy and possibility for analysis when comparing two sources of FCD with similar road network representations (as known as penetration rate). Hellinga, Bruce R., et al., “Reducing bias in probe-based arterial link travel time estimates,” Transportation Research Part C: Emerging Technologies 10.4, 257-273 (2002) describe an example of an analysis/visualization (Origin-Destination matrices) which is possible to do with FCD and not with RTS, where the demand in terms of mobility from/to different geographical area of interest (GAOI) regions is accurately estimated throughout flow counts (typically done in a time-dependent fashion).

The data filter embodiment (FIG. 4 in U.S. Pat. No. 7,912,628, and U.S. Patent Application Publication No. 2007/0208493) is focused on individual samples instead of groups of samples. Moreover, this filter merely aims to remove irrelevant data by simply removing GPS traces reported to be outside the GAOI. The suggested filtering process has nothing to do with the FCD quality, which is not evaluated either in an individual or aggregated perspective.

The data outlier eliminator routine (FIG. 5 in U.S. Pat. No. 7,912,628, and U.S. Patent Application Publication No. 2007/0208493) analyzes groups of samples of data aggregated by road segment instead of by source. Again, it is focused a signal veracity-type of indicator, the reliability, by trying to filter out unreliable data samples by excluding them by extreme derived values (e.g., excessive link speed). Even when excluding samples, it excludes individual measurements instead of excluding a data source entirely.

CN 101270997 describes a system to estimate the traffic status from FCD which includes map-matching activities. The data filter is focused on individual samples. Moreover, this falterer merely aims to replace inaccurate samples by accurate estimations of the real trajectory of the vehicles.

### SUMMARY

In an embodiment, the present invention provides a method of filtering FCD sources. A plurality of indicators are computed for each of the FCD sources from data received from the FCD sources. The indicators include at least one indicator that indicates a veracity of the data and at least one indicator that indicates a value of the data. A unified quality indicator is computed for each of the FCD sources from the respective indicators. The unified quality indicators are compared to a predetermined threshold. The data received from the FCD sources is stored excluding, based on the comparison, the data received from at least one of the FCD sources.

In another embodiment, a filter implements the method using one or more processors configured to compute the indicators and the unified quality indicator.

In another embodiment, a system including the filter and a memory can use only the portion of the saved data for current or future traffic status determinations by server devices.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1A shows a typical visualization of traffic status in real-time inferred from multiple FCD sources (image from GOOGLEMAPS);

FIG. 1B shows possible control actions that can be deployed to mitigate possible road congestions;

FIG. 2 shows a graph illustrating an example of typical data collected by a single RTS;

FIG. 3 shows an illustrative example of typical FCD collected by a single vehicle;

FIG. 4 schematically shows a system according to an embodiment of the present invention;

FIG. 5 schematically shows a system for ZETA computation for a single FCD source;

FIG. 6A shows a table with a comparative evaluation of a state of the art filter compared to a filter according to an embodiment of the present invention; and

FIG. 6B shows a table with the aggregated results of the table of FIG. 6A.

### DETAILED DESCRIPTION

Currently, the large scale availability of GPS-enabled devices has resulted in a huge number and variety of data sources capable of broadcasting such information on a microscopic level. However, the inventors have recognized that the quality of such data sources can vary greatly, especially in an urban environment. The different generations of GPS antennas and communication protocols in place (e.g. 3G/4G), as well as the road/urban topology (e.g. narrow streets, very high buildings) are some of the reasons there can be huge variations on the uncertainty of FCD sources. Nevertheless, the current trends on Big Data fusion frameworks push the TMCs to collect and use all the data sources as input to their decision support frameworks. The usage of an unreliable FCD input has three main consequences: (i) the deployment of suboptimal CTCA either by humans or machines (e.g. optimization frameworks taking into account unreliable data); (ii) an excessive storage usage which can limit the usage of such FCD sources by some TMC due to either physical or financial reasons (e.g. no money to invest/no space to deploy such large scale data storage/data warehousing) by storing unreliable/non-relevant data; (iii) an excessive memory and/or computational power usage when performing future traffic status inference using typical Analytics/Machine Learning frameworks (e.g. Larger Epoch CPU Running Time in Multilayer Perceptrons/Artificial Neural Networks to predict short-term travel times using FCD; larger volatile memory, e.g. RAM, requirements to run such algorithms). The last two consequences represent technical issues for which different technical solutions in accordance with embodiments of the present invention advantageously improve computer functionality in terms of saving storage and computational resource usage (e.g., CPU cycles and volatile memory). The inventors have recognized that an evaluation of the quality of FCD is especially advantageous to evaluate how such datasets would or would not be adequate to particular data mining tasks, such as road map generation, demand estimation or typification.

In an embodiment, the present invention provides a solution to the above-mentioned consequences by deploying a filter-type of server which, through an inventive and efficient analysis of the data broadcasted by the data sources, determines which are relevant to be input to a TMC system and which are not.

The quality of a mobility data source is inversely proportional to the effort necessary to extract meaningful and yet reliable mobility-related information. As popularity of data science grows across multiple industries, so does the price of both professionals and software/hardware frameworks in this field. Consequently, the assessment of data source quality can be key to planning data mining projects across industries. Moreover, noise usually associated to raw GPS data raises an uncertainty flag on the results side which is really undesirable for researchers, industrial practitioners and project/research managers in general.

According to an embodiment of the invention, an FCD evaluation process occurs on two distinct dimensions: (i) value and (ii) veracity. Value addresses how representative a dataset is regarding its original population (e.g., how safely can a travel pattern in a city be inferred based on such dataset). Veracity relates to how reliable a dataset may be, which can include GPS error measurements and missing data (e.g., periods of signal absence largely superior to the sampling rate). Such dimension includes sample size and rate, city spatial coverage as well as the presence/natural availability of additional types of data (e.g. weather-based).

In different embodiments, different statistical indicators are used in the evaluation process. These indicators rely on a series of statistics, unsupervised learning techniques (e.g., clustering) and external data sources (e.g., commercial road maps) that are proposed herein. In particular embodiments described herein, the indicators were applied to two publicly available probe car datasets collected from taxi fleets running in two cities: Nanjing, China and San Francisco, USA. The credibility of such indicators was also evaluated by conducting two simple machine learning experiments over an O-D matrix: (a) flow count estimation for a one-day horizon and (b) a priori travel time prediction. These experiments demonstrate insights about the knowledge that can be extracted from such datasets in an a priori fashion. The indicators can have multiple applications in the transportation industry, such as setting prices of datasets and data sources, filtering unreliable sources and feeding advanced traffic visualization/inference frameworks on TMCs.

In contrast to typical work on FCD quality evaluation, which is often only concerned with the accuracy of GPS measurements with respect to the vehicles' real positioning, the statistical indicators discussed herein provide a unified, multi-indicative set that evaluates the relevance of the data broadcasted by a FCD source in an automated way. The inventors have recognized that known schemas which focus on a single dimension are biased and not useful, taking little advantage of the large computational power and sample sizes that are available today. In contrast, the indicators in an embodiment of the present invention provide a multi criteria statistical evaluation schema which output is quantified and normalized to certain range.

In an embodiment, the invention addresses the problem of pruning unreliable, non-valuable and/or irrelevant FCD out of the data processing pipeline on traffic status visualization tools in the context of a TMC. This filtering is performed using multiple criteria taking into account not only the data Veracity, but also its Value (e.g., Spatial Coverage). The method and filter allows to drastically reduce the storage requirements of any solution for a TMC, as well as the computational power (in terms of clock cycles of a CPU) required to operate predictive analytics in this context.

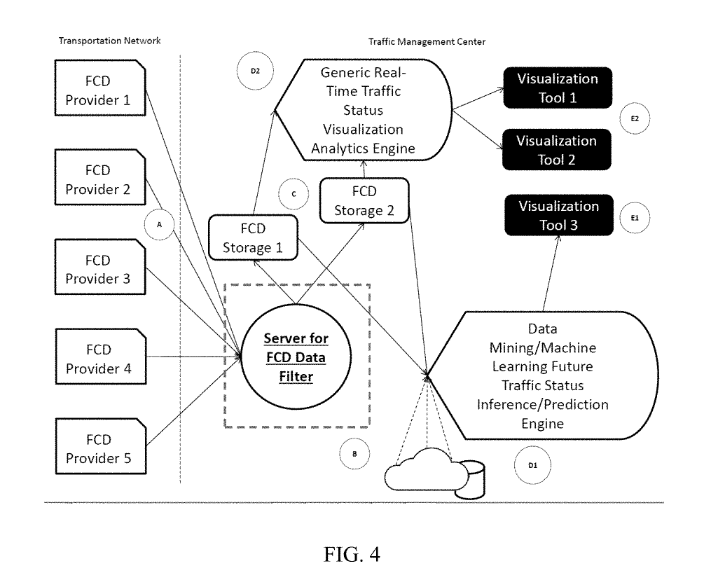

FIG. 4 shows a system diagram (wrapper/embodiment) according to an embodiment of the invention. The inventive filter is indicated by the dashed rectangle at B. In a step (A), FCD is collected by different FCD providers (e.g. taxi/bus fleets). In a step (B), some of these sources are filtered out if their quality indicator is below a certain threshold. In a step (C), traffic status is stored for a short term. Then, in a step (D2), the FCD is processed by a Generic Real-Time Status Visualization Analytics Engine which allows to depict the current traffic status in a visualization tool of interest (e.g. screen) in a step (E2). Alternatively or additionally, the FCD can be stored in step (C) on a long term to then be recurrently (re)processed by a Data Mining/Machine Learning Future Traffic Status Inference/Prediction Engine in a step (D2) in order to continuously (re)train explanatory models able to predict the short-term future traffic status for a specific GAOI. The results of such models given the current values of the explanatory variables (e.g., location, previous status, weather, etc.) are the future traffic status that can then be visualized in a visualization tool of interest (e.g. screen) in a step (El).

According to an embodiment, the invention significantly reduces the storage requirements of typical TMC visualization systems. The filter can be provided by a server containing a software component that analyzes the data broadcasted by each one of the input sources periodically, assessing its quality in terms of its Reliability and Variety (in contrast to known solutions in which the data produced by each vehicle individually takes into account aspects related to a single dimension only, i.e. Veracity) by producing a single quality indicator named ZETA E[0,1]. Then, the data broadcast by the FCD sources for which ZETA value is below a certain user-defined threshold are not kept in the TMC storage repository, thereby reducing the requirements of a storage repository (e.g. HDD) in terms of used/required capacity, occupied physical space and, ultimately, consumed power. According to this embodiment, steps (A), (B), (C), (D2) and (E2) are performed to filter out FCD sources into the Generic Real-Time Traffic Status Visualization Analytics Engine which depicts the future current estimated traffic status in a GAOI into generic Visualization Tools (e.g. screens).

According to another embodiment, the invention significantly reduces both the volatile memory (i.e., RAM) as well as the computational power required to do Short-term Inference of the Future Traffic status using Data Mining/Machine Learning (DM/ML) techniques (such as Artificial Neural Networks/Multilayer Perceptrons) by using the abovementioned filter. In this context, this type of process (i.e., supervised learning) aims to build an explanatory mathematical model that can explain causality relationships between the traffic status (e.g. the travel time required to traverse a given road link on the next 15 minutes) and explanatory variables (such as the weather, the time of the day or the historical link travel times of the surrounding road links). Typically, these models may have to be re-trained multiple times per day due to an unexpected concept drift on such explanatory models (e.g. a car accident/breakdown, a fast weather change, etc.). Such a training process typically uses historical FCD stored in the TMC's FCD storage devices (see step (C)), among other data sources. This FCD is copied into memory and several calculations (e.g. loss functions) are performed multiple times (e.g. epochs when training Multilayer Perceptron with the Backpropagation algorithm and Classical Gradient Descent) over the same data samples. By reducing the amount of data required to perform such operations accurately, the present invention allows to reduce both the volatile memory requirements as well as the computational power (i.e., number of calculations) requirements as well. According to this embodiment, steps (A), (B), (C), (D1) and (E1) are performed to filter out FCD sources from broadcasting data into the DM/ML Future Traffic Status Inference/Prediction Engine which depicts the future predicted traffic status in a GAOI into generic Visualization Tools (e.g. screens).

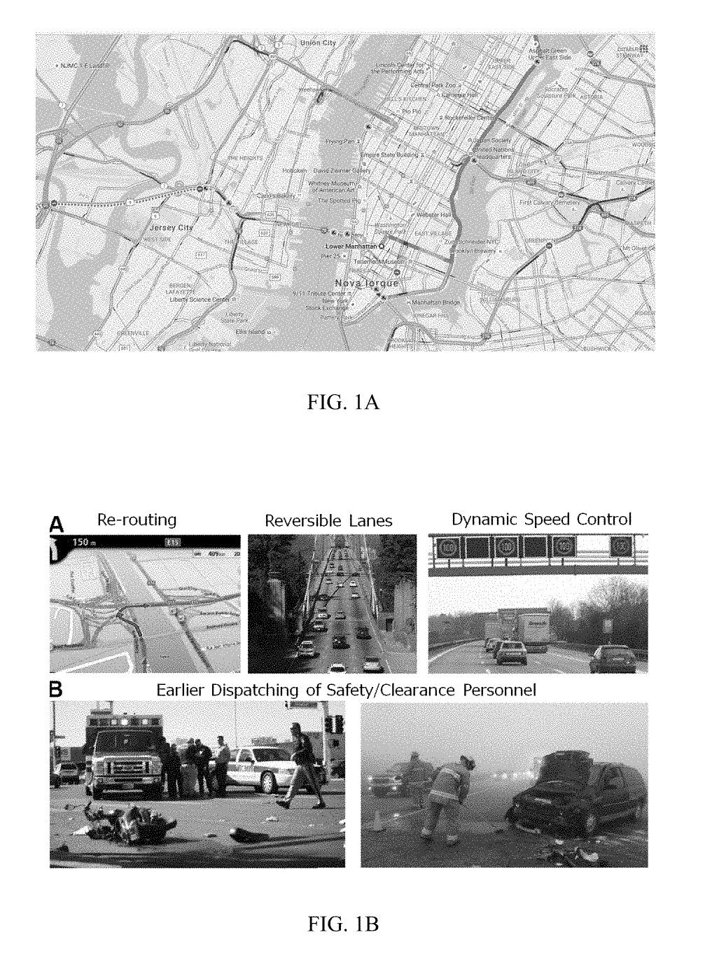

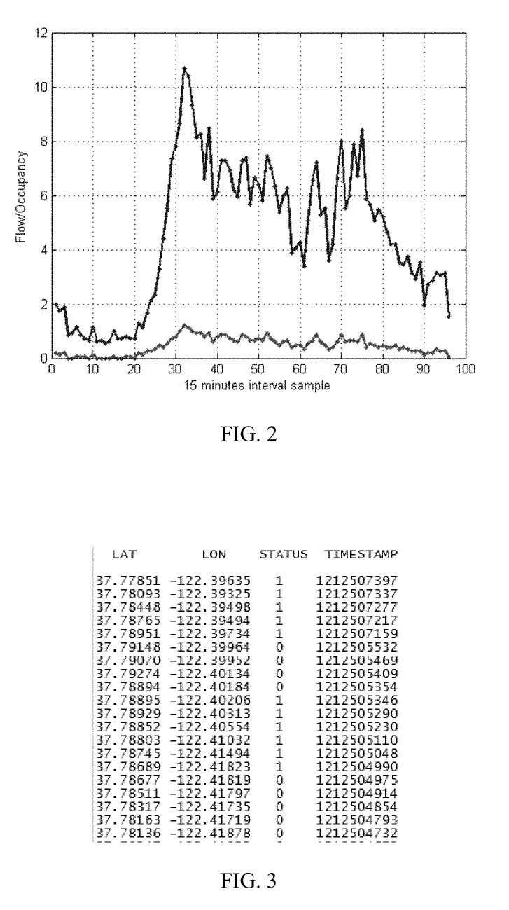

According to a further embodiment, the invention addresses the physical effect provoked by deploying automated CTCA (e.g., dynamic speed control reduction, as depicted in FIG. 1B). As discussed above, embodiments of the invention provide for performing real-time estimations and/or future short-term prediction of congestion. A hand-made heuristic based on a set of rules (e.g. if hour=peak and main avenue=congested THEN reduce maximum speed on surrounding arteries in 10%) can be put in place to deploy automatic control actions. The CTCA can be sent to displays or road signs, or provide alerts or re-routing instructions. Alternatively, the CTCA can be deployed microscopically (i.e., directly in every vehicle) in the context of autonomous cars controlled remotely and centrally by an automated regulator or TMC.

In the following, a description of numbered features/steps A-E (including noted sub-steps and alternative steps) which can be provided in different combinations in exemplary embodiments of the present invention is provided. In the exemplary embodiments, a methodology is provided which is based on an indicator set, which provides an automatic and efficient way of comparing different datasets and/or sources, e.g., for any data mining task of interest. The notation and symbols relevant to the following description are as follows:

xᵢ ∈ X GPS trace i of dataset X

G Granularity Indicator

er f c Complementary Gaussian error function

V Number of vehicles in the dataset

\tilde{δ}ᵥ Median sampling rate of vehicle v

\tilde{δ}_{G} Global sampling rate

\tilde{δ}ₒₚₜ Optimal sampling rate

Tᵥ Ratio of trips comprised by vehicle v

MaTC Macro Temporal Coverage Indicator

ndays Timespan of data, in days

ts Timespan of data, normalized

σ standard deviation

dv Diversity of dataset, normalized

ρ_{wd} Relative frequency of each weekday

θ_{wd} Ratio of unique weekdays covered

Φ Ratio of missing days

MiTC Micro Temporal Coverage Indicator

D Number of parts of day considered

ρ_{d} Relative frequency of each hour in part of day d

θ_{d} Ratio of unique hours covered in part of day d

SC Spatial Coverage Indicator

GRID City map meta-grid

nblocks GRID granularity factor

Y Relevance of a grid cell gc

cc City center geographic position

lm City landmarks geographic positions

gc^{cc} Grid cell containing city center

Y_{cc} Relevance of grid cell gc*

φ_{gc} Road density of gc

gc_{adj} Adjacent grid cells to gc

Yₘᵢₙ Minimum relevance for influence propagation

η Influence propagation factor

S_{gc} Number of GPS traces in gc

MD Missing Data Indicator

bhᵢ Black-hole in instance xᵢ

P Missing packets

T_{bh} Ratio of black-holes per trips, on average

[symbol] Median duration of black-holes

α Raw estimate of Missing Packets

n Normalizing factor

Ω_{d} Penalty factor with respect to the black-holes duration

Ωₜ Smoothing factor with respect to the median trip duration

Ψ Estimate for the average speed of vehicles

R Reliability Indicator

at Awake trace ratio

aT Awake trip ratio

rt Reachable trace ratio

rT Reachable trip ratio

κ Proportion of GPS traces that lie inside the bounding box

A Accuracy Indicator

DRN Digital Roadmap Network

tᵢ GPS trace i of trip t (tᵢ ∈ X)

eᵢ Accuracy discrepancy in GPS trace i

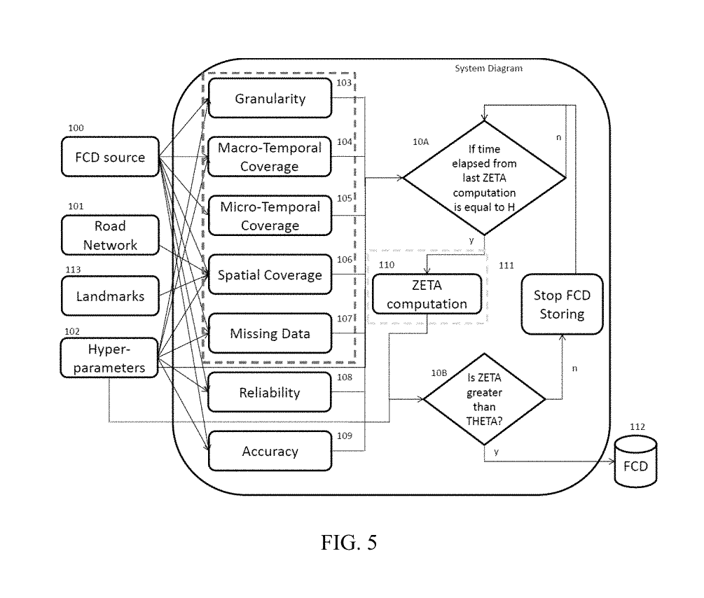

eₜ Mean accuracy error in trip t
A) Multiple FCD providers (e.g. different fleets of vehicles) will both produce and broadcast FCD describing their mobility on a given GAOI.
B) A Unified Quality Indicator (i.e. ZETA) is computed for each FCD provider based on the most recent data broadcasted by each one of the FCD providers (e.g., a temporal sliding window of size H where H is a user-defined hyperparameter). If this Indicator goes below a certain threshold THETA ∈[0,1] for a given source, the data of this source is not passed to the components downstream. This Unified Quality Indicator takes in consideration multiple criteria covering two dimensions: Value and Veracity. The sub-steps B1-B7 for performing this step are described below. It is important to note that the formulae necessary to compute any of the seven indicators as well as the one used to combine them into the Unified Quality Indicator (i.e. ZETA) are exemplary embodiments of the invention. The invention covers filters, and the physical effects thereof, which prune out unreliable FCD sources (from a macroscopic point of view) using a combination of normalized qualitative data quality indicators with respect to different factors which cover the two dimensions, Veracity and Value. Veracity is based on evaluating the potential reliability of the provided data. Value is focused on assessing the potential of the dataset in terms of the information it may possess, and evaluates the quantity of data provided, in both space and time. Sub-steps B1-B4 are related to Value and sub-steps B5-B7 are related to Veracity. The indicators measuring the Veracity of the dataset allow to analyze how much information and sense of causality can actually be extracted. The sub-steps B1-B7 in this exemplary embodiment describe the computation of seven distinct statistical indicators which quantify the data quality in a continuous number ∈[0,1] with respect to one single aspect; the last one corresponds to the computation of a combination of those seven indicator values into the Unified Quality Indicator. In other words, the indicators can be expressed in a scalar between 0 and 1, where 1 stands for an optimal quality indicator, though other expressions are also possible. Such normalization of each statistical indicator output turns such quality evaluation results on different aspects to be comparable among themselves as well as the ones produced from different FCD sources, providing a fair comparison test bed. Using such a set of parameterizable indicators, diverse in application yet invariant in interpretation, results in standardized and more expressive evaluation criteria of datasets. The analysis of mobility, where concept drift is recurrent, can thereby be improved. The system diagram for the computation of ZETA for a single FCD source is shown in FIG. 5. Here, the filter, or filter-type server, performs multiple parallel computations of the ZETA/Unified Quality Indicator (one per FCD source) based on the flowchart presented in this diagram.
B1) Granularity (G) provides insight about the frequency of the GPS traces transmitted from a given vehicle. This frequency is known as sampling rate. A dataset with a high sampling rate is valuable in the sense that it is possible to retrieve information on a vehicle with higher temporal precision, facilitating the tracking of that vehicle. This is particularly advantageous for several tasks in transport systems, such as map-matching or congestion prediction. It is expected that as the sampling rate increases, map matching gets easier, especially in an urban environment where streets are typically small and the uncertainty in data increases. Granularity is evaluated by measuring the sampling rate across all vehicles comprising the dataset. The granularity sub-step preferably outputs a continuous value indicator ∈[0,1] of the quality of the dataset with respect to this aspect. This is a value type of indicator. Granularity can be evaluated using the following equation:

$$\begin{matrix}{δ}_{G} = {\sum }_{v = 1}^{V} {\tilde{δ}}_{v} \cdot {T}_{v} : {T}_{v} ∈ [ 0 , 1 ] & ( 1 ) \\ G = \{ \begin{matrix}1 , & if {δ}_{G} < {δ}_{opt} \\ erfc ( {δ}_{G} - {δ}_{opt} ) , & otherwise\end{matrix} & ( 2 )\end{matrix}$$

where V denotes the number of distinct vehicles in the dataset, \tilde{δ}ᵥ is the median sampling rate of vehicles v and er f c is the complementary Gaussian error function. δ_{G} represents the global sampling rate. δₒₚₜ denotes the optimal value of sampling rate, which is a user defined parameter. The intuition behind such formulation is to find a global sampling rate in the dataset. This can be accomplished by averaging the median sampling rate of each vehicle, accounting for the prevalence of each vehicle. The reason for this is because a dataset probably has many vehicles with different GPS devices. Thus, each vehicle's sampling rate is weighted by the number of trips each has performed as a way to measure the prevalence of the vehicle in the data. Granularity is just a linear transformation with a complementary Gaussian error function. A scalar between 0 and 1 is obtained, which is defined as the granularity of the dataset. Moreover, the use of the median as a centrality measure (as opposed to the typical arithmetic mean) is motivated by its greater robustness to outliers, which the sampling rate is prone to. Despite its insights, granularity lacks temporal and spatial context. To complement that measuring, it is proposed according to an embodiment of the invention to analyze the range and diversity of those GPS traces both on space and time, as discussed with reference to the indicators below.
B2) Macro Temporal Coverage (MaTC) evaluates the temporal coverage of FCD at a high level. This can be accomplished by measuring the timespan and diversity of a dataset in a time scale of one day (e.g., is it covering all weekdays or just Fridays?). This component preferably outputs a continuous value indicator ∈[0,1] of the quality of the dataset. This is a value type of indicator. This indicator is particularly relevant when addressing demand forecasting tasks. In such scenarios, it is advantageous for the FCD to be as diverse as possible with respect to the population) and have a large time span. Time span ts is related to the raw size of the dataset and is computed by the following equation: ts=1−er f c(ndays), where ndays is the number of days elapsed from the first to the last GPS trace. The more days covered, the greater ts value is. On the other hand, diversity is related to the spread of weekdays covered: dv=(1−\sqrt{σ(ρ_{wd})})·θ_{wd}, where σ(ρ_{wd}) (is the standard deviation of the relative frequency of each weekday and θ_{wd} is the ratio of unique weekdays covered (1 if all weekdays are covered). Finally, the value of MaTC is computed taking the arithmetic mean of the ts and dv, along with a penalty Φ, which stands for the ratio of missing days in the dataset (i.e., days without any GPS trace), for example, as follows:

$$MaTC = \frac{ts + dv}{2} \cdot Φ \qquad ( 3 )$$

where FCD is considered to have good macro temporal coverage if it comprises a large time span with a uniform distribution of weekdays. The main drawback of MaTC arises from its high level formulation. As such, a single GPS trace is enough to consider a day as covered. Nonetheless, this issue can be taken into account in the indicator formulated below.
B3) Micro Temporal Coverage (MiTC) is intuitively similar to the MaTC. The main difference is that MiTC is computed in a finer time scale, e.g., within the day. Here, it is possible to understand how well the data is covering all parts of the day (e.g., morning and evening). The absence of one of these components provides an understanding of in-day seasonalities, which is one key component in transportation-related data mining tasks. Preferably, a continuous value indicator ∈[0,1] of the quality of the dataset is output with respect to this indicator. This is a value type of indicator. Some examples of related phenomena are rush hours or demand peaks generated by a given event (e.g. soccer match). MiTC can be computed as follows:

$$MiTC = \frac{{\sum }_{d = 1}^{D} ( 1 - \sqrt{σ ( {ρ}_{d} )} )}{D} \qquad ( 4 )$$

where θ_{d} is the ratio of hours covered in part of day d and σ(ρ_{d}) is the standard deviation of the relative frequency of the hours with that same part. The final value for the indicator is computed through the mean value across all parts in D. Similarly to the previous indicator, the expressiveness of the deviance to the relative frequency is leveraged in order to measure its diversity. Achieving high levels of diversity is advantageous for data mining tasks for creating a model that generalizes to the population. For example, a learning model which is trained using only observations from the morning periods will have, in principle, difficulties generalizing to the evening period.
B4) Spatial Coverage (SC), as opposed to indicators B1, B2 and B3 which are mostly related to the temporal component of the data, is an indicator addressing the spatial side of FCD. Here, a series of GPS traces positions are taken and it is measured how well they are spread across the GAOI. According to an embodiment, the SC is computed in a non-trivial fashion and provides a significant advancement over what is known. Instead of simply dividing a GAOI in grids and counting how many of them are covered by an FCD source (e.g., by counting the number of traces within), an embodiment of the present invention performs the computation on a continuous space by taking into account the notion of relevance of each cell. This relevance will set a weight for each grid that is then used to combine the baseline evaluation of how well each grid is covered by an FCD source. The relevance of each cell can be computed based on the landmarks/hotspots contained within (e.g., hospitals, transportation hubs, commercial areas), as well as on their road network density. This relevance is also computed taking into consideration the notion of propagation relevant on traffic/congestion status analysis. According to an embodiment, a heuristic is provided which firstly assigns a native relevance to each grid and then propagates it throughout each neighborhood till some sort of convergence is achieved. Preferably, a continuous value indicator ∈[0,1] of the quality of the dataset is output with respect to this indicator. This is a value type of indicator. Thus, SC measures the spatial diversity of FCD. Particularly, its value increases as the spread of the GPS traces across the map also increase. However, since some areas of a city have greater demand than others (e.g., downtown), it is not sufficient to count how many GPS traces end up where. Therefore, an embodiment of the invention takes into consideration the relevance of each zone. First, the city can be decomposed into a more manageable format. One simple approach for this is to decompose the city into a grid of equally sized cells of nblocks by nblocks. The relevance (Y) of each one of the grid cells is quantified. In order to formalize Y of a grid cell, a rule can be used to generalize. In effect, the grid cell containing the city center (cc) is used as a baseline. The relevance of the rest of grid cells is quantified by measuring their:

(i) road density: One naive way to estimate the importance of a chunk of map in terms of mobility is by the number of possible ways there is to cruise that chunk. The road density of a grid cell gives a rough estimation of how many roads it covers. The more roads there is for a vehicle to cruise in a grid cell the higher its importance. We start by assigning relevance Y_{cc} to the grid cell containing the city center. The relevance of all other cells is given according to this baseline, with respect to. their road density. This is formalized in Algorithm 1 below;

(ii) proximity to landmarks and other hotspots (e.g., city center, hospitals, airport), lm: Most vehicle destinations are set to the whereabouts of points of interest such as the downtown, shopping centers, airports, and so on. This is the rationale behind the variable of landmark importance. City areas with more points of interests will have higher importance than others. To input the landmark importance Algorithm 2 below can be used, in which all grid cells containing at least one landmark are assigned the maximum value for relevance; and

(iii) neighborhood, proximity to other important grid cells: The final main indicative of importance of a grid cell is their inter-connectedness. In other words, a grid cell is deemed of some importance if it serves as intermediate to other important grid cells. A grid cell may be of notable relevance, even if it does not have a reasonable road density or is close to any landmark. Being adjacent to any important grid cell is also an important factor, because it serves and intermediates. For example, the grid cells adjacent to the one containing the airport are of some relevance just for that fact. The Algorithm 3 below can be used to improve the relevance of the neighborhood cells considering the relevance of each cell. If a given grid cell gc has Y_{gc} below some threshold Yₘᵢₙ , the relevance of its adjacent grid cells gc_{adj} positively influences its relevance by a factor of η.

where combining these three variables provides a reasonable notion of which parts of the city are more important in terms of urban mobility. The whole procedure for determining SC, in an embodiment, is described in Algorithm 4. The city is split into several chunks and it is measured how well each chunk is covered (i.e., counting GPS traces) with respect to the weights of those chunks, which are featured by a relevance measure Y. In other words, the total number of GPS traces in a a given cell gc(S_{gc}) is weighted according to its relevance φ_{gc}.

Algorithm 1 Υ Estimation with Road Density

| | | |
|---|---|---|
| 1: | Input: | Grid Cell gc ∈ GRID, cc geographic position, road density φ_{gc} |
| 2: | Output: | Relevance of gc, Υ_{gc} |

| | |
|---|---|
| 3: | gc^{cc} ← grid cell containing city center |
| 4: | Υ_{gc}_{^{cc}} ← Υ_{cc} |
| 5: | return Υ_{gc} = (Υ_{cc} · φ_{gc})/φ_{gc}_{^{cc}} |

Algorithm 2 Landmark Importance Imputation

| | | |
|---|---|---|
| 1: | Input: | Grid Cell gc ∈ GRID, lm geographic position, Υ |
| 2: | Output: | Updated Relevance of gc, Υ_{gc}, ∀gc ∈ GRID |

| | |
|---|---|
| 3: | if gc contains any landmark |
| 4: | then Υ_{gc} = max (Υ) |
| 5: | end if |
| 6: | return Υ_{gc} |

Algorithm 3 Influence Propagation

| | | |
|---|---|---|
| 1: | Input: | gc ∈ GRID, Υ |
| 2: | Output: | Updated Relevance of gc, Υ_{gc}, ∀gc ∈ GRID |

| | |
|---|---|
| 3: | for each adjacent grid cell to gc, gc_{adj} do |

| | |
|---|---|
| 4: | if Υ_{gc} < Υₘᵢₙ then Υ_{gc} ← Υ_{gc} + η · Υ_{gc}_{_{adj}} |
| 5: | end if |

| | |
|---|---|
| 6: | end for |

Algorithm 4 Spatial Coverage Indicator

| | |
|---|---|
| 1: | procedure GRID = GRIDDECOMPOSITION (City Map, nblocks) |
| 2: | end procedure |
| 3: | for gc ϵ GRID do |
| 4: | S_{gc} = Σ_{xϵX}xᵢ : xᵢ ϵ gc |
| 5: | Υ_{gc} = Algorithm 1(gc, cc, φ_{gc}) |
| 6: | Υ_{gc} = Algorithm 2(gc, lm, Υ) |
| 7: | Υ_{gc} = Algorithm 3(gc, Υ, gc_{adj}) |
| 8: | end for |
| 9: | $return SC = \frac{{\sum }_{gc ϵ GRID} ( {S}_{gc} \cdot {ϒ}_{gc} )}{{\sum }_{gc ϵ GRID} {ϒ}_{gc}}$ |

B5) Missing Data (MD), as opposed to the indicators presented above which address the representativeness of the data with respect to its population, delves onto a different component of data and analyzes how reliable it is, or its veracity. In most knowledge discovery applications, the notion of missing value is a well-defined concept. However, with respect to FCD, there is no clear-cut definition as to what a missing value is. Generally, a GPS device transmits signals to the data center at a well-defined rate. However, there may be huge gaps of time between two transmitted signals within a trip that, according to an embodiment of the invention, are treated as missing data. This issue may be caused by malfunctions on the devices or human misuse, and is an important characteristic to describe in a dataset. The existence of a time gap, or the missing of one or more data points, can be considered, for example, if the time elapsed since the last transmission falls above two times the median sampling rate of the vehicle in question. Preferably, a continuous value indicator ∈[0,1] of the quality of the dataset is output with respect to this indicator. This is a veracity type of indicator. This concept is formalized below, where bhᵢ represents what is defined herein as a black-hole in a GPS trace xᵢ ∈ X:

bhᵢ [symbol] _{Δt}_{(i,i-1)}≥2·\tilde{δ}ᵥ

where it is noted that one issue that arises from this proposed definition for black-holes is that different black-holes may be of different time periods. This motivates the notion of missing packets (P). Given the global sampling rate δ_{G} introduced above, missing packets are the number slots (1 δ_{G} represents 1 slot) of the δ_{G} that are missing, on average. This is formally defined as follows:

$$β = \{ \begin{matrix}⌈ {r}_{bh} ⌉ & if {r}_{bh} \leq 5. \\ 5 , & otherwise .\end{matrix} \qquad ( 5 )$$

where r_{bh} is the ratio of black-holes per trip, and ┌r_{bh}┐ is ceiling value.

$$\begin{matrix}n = \{ \begin{matrix}1 , & if α \leq 1 or β = 1 \\ ( α - 1 ) \frac{β \sqrt{β}}{5 \sqrt{5}} , & otherwise\end{matrix} & ( 6 ) \\ α = \frac{{r}_{bh} \times \tilde{bh}}{⌈ {r}_{bh} ⌉ \times {δ}_{G}} & ( 7 ) \\ P = \frac{{Ω}_{d} \times α}{n \times {Ω}_{t}} & ( 8 ) \\ MD = \frac{erfc ( P ) + G}{2} & ( 9 )\end{matrix}$$

where in Equation (7), [symbol] stands for the median duration of black-holes. In Equation (8), α gives a raw estimate of how many packets are lost. A normalization factor n is used to smooth that value for the cases where those lost slots are spread across the dataset. In other words, supposing that p packets are lost, the value is toned down the more those p missing packets are spread across the time span and is not just one big black-hole. Furthermore, a penalty Ω_{d} can be added that takes into account the deviance of the black-holes duration. Conversely, P can be smoothed by a factor Ωₜ with respect to the median duration of trips. In the final step, Equation (9), this value is averaged with the granularity value G (see above) to tone the effect of the missing packets according to the sampling rate of the data.

B6) Reliability is an indicator for another issue when analyzing the veracity of a dataset which is related to its logical sense regarding the GPS positions, as opposed to MD which assesses the robustness of FCD in terms of completeness of its database. Some counter examples (e.g., illogical observations) would be: i) GPS positions in Mexico when performing mobility analysis on Italy; ii) a vehicle in a given position at one timestamp and then 100 kilometers away after only 10 seconds. Reliability aims at addressing such points. Preferably, a continuous value indicator ∈[0,1] of the quality of the dataset is output with respect to this indicator. This is a veracity type of indicator. According to an embodiment, the following definitions are used:

Definition 1: A GPS trace xᵢ is awake if the traveled distance from the previous transmitted signal (Δ d₍ₜ_{ᵢ}_{,t}_{_{i−1}})) is greater than the respective sampling rate:

xᵢ awake [symbol] Δd₍ₜ_{ᵢ}_{,t}_{_{i−1}})>δᵢ

where, as an example, a given vehicle with a sampling rate of 10 seconds (from its previous transmitted signal) is awake if it traveled at least 10 meters from its position in that previous signal. From Definition 1, two values are computed: awake trace ratio (at), which is the ratio of awake traces across the data; and awake trip ratio (aT), standing for the ratio of trips that have a percentage of awake traces greater than a given threshold ∈. This concept advantageously arises from the fact that while a vehicle may be providing a vast amount of data, it can be useless if the vehicle is not moving. A taxi cab, for example, may be parked for long periods of time.

Definition 2 A GPS trace xᵢ is reachable if the traveled distance from the previous transmitted signal is within a given threshold Ψ, where Ψ is given by a estimate of the average speed times the respective sampling rate:

xᵢ reachable [symbol] Δ d₍ₜ_{ᵢ}_{,t}_{_{i−1}})>δᵢ·Ψ

where the analysis of reachability of vehicles is used, in an embodiment, for uncovering dubious data, e.g., from malfunctions of GPS devices or synthetically inputted data. From the Definition 2, two more ratios are computed: (1) reachable trace ratio (rt), which is the ratio of reachable traces across the data, and (2) reachable trip ratio (rT), which is the ratio of trips with all its comprising points reachable. Finally, Reliability is computed as the mean of the four values described above, at; aT; rt; rT, toned down by a penalty κ, representing the proportion of points that lie inside the bounding box. The bounding-box can be thought as a meta-rectangle that delimits the underlying map.

$$Reliability = \frac{at + aT + rt + rT}{4} \cdot κ \qquad ( 10 )$$

where the Reliability indicator covers the objectivity of the dataset. Particularly, Reliability aims at certifying that the GPS traces are logically possible, both in spatial and temporal terms. The advantages of such an indicator include: i) uncovering anomalous data, i.e., data that for some reason (e.g. device malfunction) includes dubious positions, times and/or space; ii) detecting synthetic data, which is not representative of the underlying probe car data population space. One drawback of the reachability values can be lack of context. For example, it would be simple to create a Markov chain to generate some synthetic data and fool these ratios. However, this issue can be advantageously addressed in an embodiment of the invention with the Accuracy indicator, comparing the data points to a Digital Road Network Map (DRN).
B7) Accuracy is an indicator that works by measuring the average discrepancy between a position given by the GPS device and an estimated true position of the vehicle. The true position can be estimated via a map-matching procedure of the GPS device positions to a DRN. This is a veracity type of indicator. There are several known approaches for the map-matching task which can be applied, such as in CN 101270997 which is hereby incorporated herein by reference, but this can be a particularly tricky problem for FCD in urban environments, where in a small range there can be many candidate roads as matching possibilities. Nevertheless, the computation of the Accuracy indicator is orthogonal to the method of map-matching. Whereas the Reliability indicator measures the reliability of data in an abstract level where lack of domain context can be a drawback, the Accuracy indicator overcomes this issue by being a more context-aware indicator. Effectively, the map-matching procedure extracts the point-wise error of GPS measurements, that is, eᵢ∀tᵢ ∈ X where tᵢ represent the GPS traces within a trip t, which belong to the set of all GPS traces X. The error measurement of a trip t is estimated by taking the arithmetic mean of the errors of each GPS trace comprising t. In turn, the general error measurement of the dataset is computed by taking the median value of e_{T}, the vector containing the error of each trip. The median can then be used to combine the scores across trips in the interest of robustness (e.g. different GPS devices, vehicles, etc). Finally the Acc function can be used to transform the estimated value to the interval [0, 1] as provided for in Algorithm 5 below.

Algorithm 5 Accuracy Indicator

| | |
|---|---|
| 1: | Input: Set of trips T, DRN |
| 2: | Output: A value |
| 3: | for each trip t do |

| | |
|---|---|
| 4: | procedure MAP-MATCHING(t, DRN) |

| | |
|---|---|
| 5: | Return eₜ, estimated error measurement of the GPS |
| | traces containing t |

| | |
|---|---|
| 6: | end procedure |

| | |
|---|---|
| 7: | end for |
| 8: | e_{T} =< eₜ >, ∀t ∈ T |
| 9: | return A = Acc(median(e_{T})) |

B8) A Unified Quality Indicator Calculation (i.e. ZETA) can be performed using preferably all of the indicators B1)-B7) described above, or different combinations thereof. In sum, the set of indicators B1)-B7) discussed above aims at uncovering the real value of FCD in an interpretable way. The methodology provides a tool for analyzing FCD, saving processing and preprocessing time and guiding to some important characteristics of the FCD datasets. Typically, the quality FCD sources is assessed in a microscopic (the data of each vehicle is evaluated independently of the data of others) and binary (e.g. GOOD/BAD) ways based on singular veracity-based indicators (typically, using (B6) accuracy and/or (B7) reliability indicators,). In contrast, the abovementioned indicator set B1-B7 provide an interpretable evaluation of the quality of each FCD source on a macroscopic way (i.e. taking into account the entire fleet) which can be compared among different aspects. ZETA can be computed in multiple alternative ways, which correspond to alternative exemplary embodiments for this step. A list of a few possibilities is provided below (B8A-B8D):
B8A) Arithmetic Mean: This computation simply averages the indicator values, penalizing the sources which have relatively poor results in one or two particular indicators. The selection is then made by a fixed THETA value provided by the user.
B8B) Weighted Average: This computation averages the indicator values while increasing or decreasing the importance of some of them. This may be important to tailor the data for certain applications such as road network discovery, where the B4) spatial coverage is very important and given the highest weight, or map matching, where the indicators of the value dimension (B1-B4) are not that relevant and are weighted lower than the veracity type indicators. The selection is then made by a fixed THETA value provided by the user.
B8C) Median: This computation takes the median of the indicator values. This is particularly advantageous in an embodiment for obtaining a value more characteristic of the quality of the data provided by each source, ignoring eventual extreme values for a particular indicator subset. This is also advantageous when dealing with a very large set of sources and being used in combination with a restrictive THETA value. The selection is then made by a fixed THETA value provided by the user.
B8D) THETA adaptive: This computation combines any of the previous methods with an adaptive value of THETA. THETA can vary, e.g., with the number of provided sources, the time of the day or even with the probability distribution of the indicator values (in order to guarantee that at least one source is always selected).
C) The high-quality FCD is stored, preferably in a data repository/storage (e.g. HDD).
D2) A Traffic Status Server powered by a Generic Real-Time Status Visualization Analytics Engine outputs a current estimation of the traffic status on a given GAOI leveraging on a statistical framework fed by the stored high-quality FCD.
E2) The real-time traffic status estimations are passed to a visualization tool (e.g., monochromatic/256 colors/millions of colors screens built upon CRT, LCD or OLED monitors) which depicts the current traffic status of the network (e.g., link speeds based on 5 minutes aggregation of data).
D1) Alternatively or additionally to steps A), B), C), D2) and E2) above, steps A), B), C), D1) and E1), where, in step D1) a Future Traffic Status Server powered by a Data Mining/Machine Learning Future Traffic Status Inference/Prediction Engine outputs the future prediction of the traffic status on a given GAOI leveraging on a machine learning/data mining framework fed by the stored high-quality FCD.
E1) The future traffic status estimations are passed to a visualization tool (e.g. monochromatic/256 colors/millions of colors screens built upon CRT, LCD or OLED monitors) which depicts the current traffic status of the network (e.g. link speeds based on 5 minutes aggregation of data on an future time horizon of 15 minutes).

FIG. 5 is a system diagram for the ZETA computation for a single FCD source. The filter, or filter-type server (see step B) described above and the dashed rectangle in FIG. 4)), performs a parallel and individual computation of ZETA for each FCD source. The system includes FCD source(s) and the topology of the road network of a given GAOI 101 (e.g., id of each road, number of lanes/directions, width of each lane, length of each road, information about to which roads it is connected). The hyperparameters 102 of the framework include all the hyperparameters necessary to compute each one of the individual indicators, for example, those discussed above with respect to the indicators B1)-B7) and/or as detailed in Table II below which play a role in each indicator's formulae explained above, plus two hyperparameters of the framework: THETA ∈[0,1], a threshold to filter out unreliable/invaluable FCD sources and H EN, the size of a periodic window of time for which the FCD source is evaluated. A source of land-use and landmark location and type 113 (e.g. hospitals, soccer stadium, major transportation interfaces, etc.) can also be provided. For each ZETA computed for each FCD source 100 in parallel, the inputs 101, 102 and 113 are preferably the same so that every FCD source is evaluated fairly (under the same parameterization of hyperparameters 102 and over the same GAOI 101). The computations 103-109 denote the computation of each one of the respective seven indicators described in sub-steps B1-B7) above. Logical building block 10A tests if there is already a sufficient amount of data to perform a novel evaluation of ZETA. Computation 110 corresponds to the sub-step B8), the computation of ZETA using the values output by computations 103-109. Another logical component 10B of the system tests if the data broadcast by the FCD source can be stored on, not in, the TMC storage repository (i.e., memory component 112 in this diagram, step C) of the TMC system wrapper shown in FIG. 4) given the last known data quality evaluation (computed in computation 110). If not, an alarm can be triggered to stop the storage of the data produced by all the vehicles correspondent to this FCD source. The computations 103-107 shown in the dashed box, and the computation 110 shown in the lighter dashed box each represent inventive features possible in different embodiments of the present invention, in combination with the other features.

Different embodiments of the invention provide significant advancements over known procedures for evaluating FCD. A typical evaluation of FCD is done in a microscopic way, by evaluating the quality of the time-stamped geolocations of a single vehicle in a standalone fashion, thus ignoring all remaining vehicles in each singular evaluation. The concept of quality to is restricted to physical aspects, and is limited to evaluating the precision of the GPS measurements (e.g. how far these are measurements from the ground truth, i.e. the trajectory cruised by the vehicle in real-world or how reliable these measurements are, e.g., this distance cannot be physically cruised in that time span; it is an outlier).

There are four aspects to take into consideration when characterizing an FCD evaluation: (i) aggregation level (microscopic/macroscopic); (ii) criteria (singular/multiple); (iii) dimensions (singular/multiple) and (iv) interpretability (binary/continuous). Typical FCD evaluation frameworks evaluate the FCD from a (i) microscopic point of view using either (ii) singular or a couple criteria from the veracity point of view (i.e., (iii) singular dimension) with a (iv) binary interpretability by either excluding/replacing or excluding/including the samples (e.g., limited binary interpretability by excluding/including samples or limited binary interpretability by excluding/replacing erroneous samples).

In contrast, the server-filter module according to an embodiment of the invention has a radically different approach to evaluating FCD: (i) macroscopic; (ii) multiple criteria covering (iii) multiple dimensions, outputting (iv) a continuous value which provides an extended interpretability of the performed evaluation. This server-filter is created departing from a principle where there are multiple and overlapping FCD sources to describe the mobility in a GAOI.

In a preferred embodiment, the steps B1)-B4) and B8) reflect the two advantageous evaluations of FCD sources with multiple criterion using qualitative indicator values which are comparable among themselves. Such continuous evaluation allows for an evaluation on the two distinct dimensions of FCD simultaneously: veracity and value.

In particular, in an embodiment, the step B4), the Spatial Coverage indicator computation, is considered to significantly differ from any known approach and provide significant advantages. For example, step B4) evaluates FCD quality from a unique perspective (i.e. spatial coverage) in a completely new way. In particular, it not only considers the absolute concept of spatial coverage by computing the percentage of the GAOI covered by the FCD source, but also what the relevance of such coverage is. It does so by taking into account landmarks, land usage, road network density and also a near-optimal concept of neighborhood computed by a heuristic of interest to propagate the relevance concept (i.e., an area close and connected to a relevant area is also relevant area as well). Such computation allows to exclude highly accurate FCD sources which describe mobility on non-relevant areas (e.g., a car-sharing company that operates residential areas on the city outskirts as last mile operator between each individual's house and a mass public urban transit interface hub) or in a very narrow area (e.g., taxi fleet operating only in the airport stand).

With respect to the step B8), the Unified Quality Indicator Calculation (i.e. ZETA), the different formulae proposed for the computation of ZETA (e.g., B8a, average of the seven indicators values) can be particular advantageous based on different criteria discussed above. The fact FCD is assessed based not only on a single indicator or on multiple indicators from a single dimension (e.g., veracity) but on multiple indicators from the FCD evaluation dimensions (veracity and value) advantageously allows to prune out FCD sources that, despite being fairly accurate, fail to provide value to an application by describing mobility on reduced contexts (such as some periods of the day or just a few subareas of the GA00. In an embodiment, such multi-criteria evaluation is streamlined because the base evaluation indicators output continuous and normalized values (all are ranged between 0 and 1), which allow them to be comparable and easily merged into a singular indicator by employing a statistical punctual estimation of interest (proposed, in an embodiment of the invention, to be the arithmetic mean). As discussed above, other examples of possible embodiments could be a median or a weighted average for use-cases scenarios where some dimensions/criteria are more important than others).

With respect to step B1), the Granularity indicator computation, by evaluating how good the frequency of the FCD provided by a given source is, this indicator highly limits the computation of other relevant statistics (e.g., link travel times of small road section will have a reduced number of samples since most of the vehicles will traverse it without collecting/broadcasting a data sample in the meanwhile) or even of veracity quality indicators, such as the Accuracy indicator. In an embodiment, a continuous output of this indicator can be guaranteed by employing an inverse sigmoid function (erfc) on its computation which expresses the probability of receiving a highly frequency stream of FCD from a singular vehicle of that fleet.

With respect to the steps B2) and B3), the Micro/Macro Temporal Coverage indicators, by including on the FCD quality evaluation a component addressing the temporal coverage dimensions covered by the FCD of a given source, it is possible to prune it out if it just covers just a small time-span (e.g., weekends on car-sharing companies or peak hours on bike-sharing companies).

Illustrative example:

A small-scale (real systems may have 10-30 FCD providers with much more vehicles) illustrative example of 7 fleets supplying FCD to a TMC covering METROPOLIS as a GAOI was used to compare two filters (filter-type servers) implementing a TMC traffic visualization/inference engine according to an embodiment of the invention: the server (SA), using a common veracity-based FCD quality evaluation considering accuracy and reliability, and the server (SB), using ZETA. For illustration purposes, THETA=0.75 and H=one week for the server (SB) while the server (SA) will use the same ZETA considering only the indicators Reliability and Accuracy (steps B6) and B7), respectively). For simplicity, this embodiment highlights one aspect of the improvements to computer functioning, in particular the effects on storage savings. It is assumed that each data sample (a time-stamped GPS location) occupies 1 Kb.

The fleets are the following: (F1) mass transit bus fleet operating in METROPOLIS; (F2) a main taxi fleet operating in METROPOLIS; (F3) a taxi fleet operating in the METROPOLIS airport; (F4) a car sharing fleet operating in METROPOLIS; (F5) FCD provided by private vehicles connected to a given insurance company; (F6) the trucks that operate in the garbage collection tasks in the GAOI and finally, (F7) the medical emergency vehicles operating in the public hospitals within that urban area. The description of each fleet is depicted below:

F1 contains a total of 800 vehicles from which, at most, only 25% are running simultaneously. The fleet is heterogeneous and contains different types of GPS devices installed in different generations: 50% were installed last year while the other 50% were installed 5 years ago. Similarly, the most recent vehicles are equipped with 3G while the remaining ones have only 2G+GPRS. Their schedule cover lam-midnight, while in the remaining period, only 3% of the fleet is running to maintain low-frequency services between the main O-D pairs in METROPOLIS.

F2 contains a total of 1000 vehicles operating in 8 h shifts. Typically, 30%-50% of the vehicles are running simultaneously. 80% of the fleet is GPS enabled with 3G communication system (installed two years ago) while 20% still receives the dispatching by SMS, having their location tracked by a first generation GPS device and broadcasted each 2 minutes by GPRS.

F3 contains a total of 50 vehicles operating in a daily basis only during business hours (7 am-10 pm). It is an old fleet equipped with the old 1st generation technologies in GPS tracking and communicational devices (i.e., GPRS only). They essentially do trips between the airport and locations downtown, getting immediately back to the airport after a drop-off

F4 contains a total of 120 vehicles from which only 10-20% is operating in simultaneous. The company is relatively new (6 months) and they do not have yet many clients. It is a brand new fleet equipped with the latest technologies in GPS tracking and communicational devices. Most of the time the vehicles are stopped in pre-designed drop-off/pick-up locations along the GAOI. They operate mostly during business hours.

F5 contains more than 800 subscribers only from METROPOLIS side. The GPS devices range in quality as the devices share little commonality among them. There is no standard for the equipment required to collect the data. Consequently, every client has different devices that range from 10-year old GPS antennas, personal smartphones and natively GPS-equipped vehicles. 5% of those vehicles are always running the GAOI as the fleet ranges from commercial to private vehicles to either transport passengers and/or goods.

Typically, during the business hours, 50% of those vehicles are constantly operating in the GAOI.

F6 contains 100 trucks that operate mainly between midnight and 7 am in METROPOLIS. They have low precision/low-frequency tracking vehicles, but they cover basically all the road network in the GAOI with the exception of orbital highways.

F7 reports the positioning of 100 emergency vehicles where 50% are permanently operating. They are equipped with the latest GPS and communicational systems and they operate typically at high speeds even high-density urban areas (with high buildings and other hazards to the normal GPS broadcasting activities).

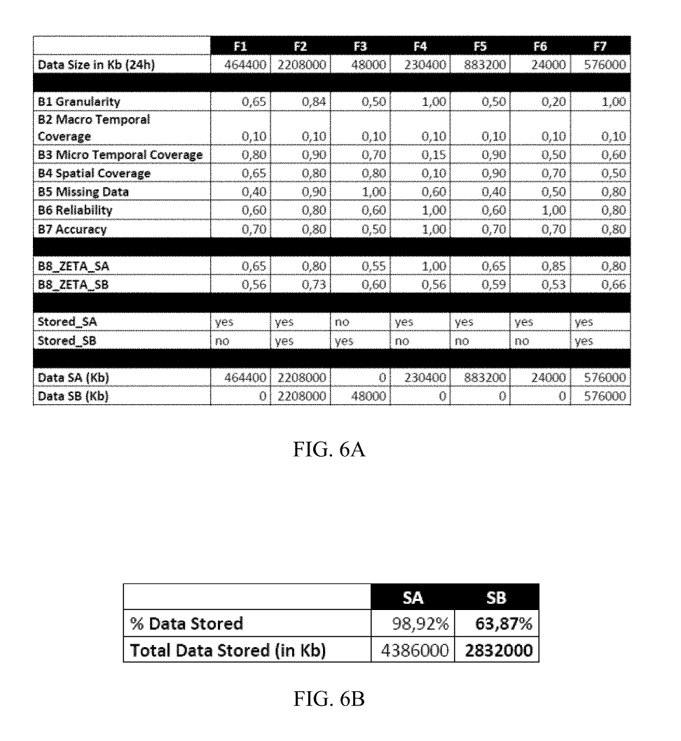

The results of an empirical quantitative evaluation of FCD quality in this scenario are depicted in FIGS. 6A and 6B. This embodiment of the invention maintains data from both valuable and reliable sources such as the two taxi fleets and the emergency vehicles. In contrast, typical approaches would mainly just classify how straightforward the GPS devices in the vehicles are, thus ignoring the main value of the FCD data: how well it describes the mobility patterns in the GAOI. It was discovered that the relative savings in terms of storage requirements between the two filter-type severs SA and SB on which this example was run on this one-day simulation are nearly 30%, as shown in FIG. 6B. Despite the decrease in storage requirements and the more effective storage of the useful FCD, this embodiment of the invention also resulted in a greater quality of the FCD overall by pruning out with the indicators discussed above.

Case Studies:

Two datasets were used as case studies. Both are from two taxi fleets operating in the cities of Nanjing (China) and San Francisco (USA). A brief description of the datasets is presented in Table I.

TABLE I
Datasets description

| | |
|---|---|
| Nanjing | San Francisco |

| No. GPS traces | 18 | million | 11 | million |
|---|---|---|---|---|
| No. Trips | 432,899 | | 959,025 | |
| No. vehicles | 7,648 | | 536 | |
| Timespan | 1 | day | 23 | days |
| Typical Trip Duration | 10 | min | 7.5 | min |

The datasets are comprised several attributes, some of which are with respect to the domain (e.g., fare type). In order to use only information that can be generalized to other FCD (i.e., not only taxi fleets) the attributes used throughout the analysis are: Timestamp, Vehicle Id, Trip Id, Latitude and Longitude.

In the following, the experimental evaluation used to validate the formulations proposed herein is described. To make such validation, a classical data mining experiment was performed. First, the parameter setting used in the case studies was formalized, as well as in the data mining experiment. Afterwards, the results are reported. Throughout the methodology, the erfc function was used to normalize some results into a standardized range of values. The general formula for er f c is:

$$Erfc ( x ) = \frac{2 \cdot a}{\sqrt{π}} {\int }_{x}^{∞} {e}^{- {t}^{2}} dt \qquad ( 11 )$$

where different parameter values were used for a according to the application. For example, in step/indicator B2), a=2\sqrt{5}/200, which in practice yields a optimal value for a dataset with a time span of one year.

Table II summarizes the parameter setting used in the experiments. For the MiTC estimation (see step/indicator B3)), each day was split into 4 equally sized parts (D=4). In step/indicator B4), the city map is decomposed into a grid of 50×500 cells. The relevance of the city center is set to 3, while the minimum relevance not to receive bonus from adjacent cells is 2. This means that all cells with relevance Y below 2 benefit from their neighborhood influence according to Algorithm 3. Furthermore, the influence propagation factor η is set to 0.3. The estimation also incorporates eventual stops (e.g. traffic lights). The penalty factors Ω_{d} and Ωₜ in step/indicator B5) are set according to Equations (12) and (13), respectively.

TABLE II
Parameter setting used in the Experiments.

| Parameter | Value(s) |
|---|---|
| erfc in B1) | a = \sqrt{2}/150 |
| erfc in B2) | a = \sqrt{2}/200 |
| D in B3) | 4 |
| nblocks in B4) | 500 |
| Υ_{cc} in B4) | 3 |
| Υₘᵢₙ in B4) | 2 |
| η in B4) | 0.3 |
| erfc in B5) | a = \sqrt{5}/10 |
| Ψ in B6) | 20 |
| erfc in B7) | a = \sqrt{6}/6 |
| cc_{nanjing} | lat = 32.05, lon = 118.76667 |
| cc_{sanfrancisco} | lat = 37.78333, lon = −122.41667 |

$$\begin{matrix}{Ω}_{d} ( dev ) = \{ \begin{matrix}\frac{dev}{500} + 1 & if dev < 150 \\ 1.3 , & otherwise\end{matrix} & ( 12 ) \\ {Ω}_{d} ( mdur ) = \{ \begin{matrix}\frac{mdur}{1800} + 1 & if mdur < 150 \\ 1.5 , & otherwise\end{matrix} & ( 13 )\end{matrix}$$

where dev is the Inter-Quartile Range of the black-holes duration and mdur is the median duration of a trip.

Algorithm 6 formalizes an approach to the map-matching problem presented in step/indicator B7). Essentially, an ad-hoc procedure was created to estimate the average GPS error measure of each trip, eₜ. Moreover, Monte Carlo approximation was used to estimate eₜ, using nreps repetitions. For each repetition, the procedure was as follows: Pick a random point tᵢ along with its next s·Lₜ−1 GPS traces, where Lₜ is the number of GPS traces comprising trip t and s is the sample size. This yields a contiguous random sample of t, tₛ. The candidate roads are then extracted from the DRN for tₛ. A road is considered a candidate if it lies inside the bounding box oft. Then, the Haversine distance dᵢ of each GPS trace tᵢ to three points in each candidate road is computed: the initial point r₁, the mean point r₂ and the end point r₃. The road that minimizes that distance is the one chosen as the one the vehicle is traversing. The error measurement of the GPS trace tᵢ is its Haversine distance to that road. The error measurement oft in the Monte Carlo repetition, eₜ^{rep}, is estimated by averaging each eᵢ, ∀tᵢ ∈ tₛ. Using the Monte Carlo approximation all eₜ are averaged across all repetitions to estimate the eₜ, the error measurement of trip t. This Monte Carlo approximation procedure is especially useful with big datasets to keep the computations tractable, providing a way to analyze all the trips for an Accuracy measure. In the experiments, nreps is set to 10, while s is set to 5%. This is a simple highly heuristic approach to the map-matching problem. However, since, according to an embodiment, a primary objective is to estimate measurement errors and not perform map-matching per se, this advantageously simple ad-hoc rule is more than adequate according to an embodiment of the invention.

Algorithm 6

| | |
|---|---|
| 1: | Input: GPS traces of trip t, DRN |
| 2: | Output: Distance of each GPS trace tᵢ, tᵢ ∈ t, to the respective |
| | predicated road. |
| 3: | nreps ← Monte Carlo repetitions |
| 4: | Lₜ ← no. of GPS traces in t |
| 5: | for each rep in nreps do |

| | |
|---|---|
| 6: | procedure SAMPLE(t) |

| | |
|---|---|
| 7: | tₛ ← contiguous random sample of tᵢ of size s · Lₜ |

| | |
|---|---|
| 8: | end procedure |
| 9: | procedure CANDIDATEROADS(t, DRN) |

| | |
|---|---|
| 10: | Return R_{c}: candidate roads for t |

| | |
|---|---|
| 11: | end procedure |
| 12: | for each GPS trace tᵢ in tₛ do |

| | |
|---|---|
| 13: | for each r in R_{c}: do |

| | |
|---|---|
| 14: | r₁ ← Initial point of r |
| 15: | r₂ ← Mean point of r |
| 16: | r₃ ← End point of r |
| 17: | dᵢ^{r} = min (Dist(tᵢ, r₁), Dist(tᵢ, r₂), Dist(tᵢ, r₃)) |

| | |
|---|---|
| 18: | end for |
| 19: | rᵢ^{s} = {r ∈ R_{c} : d^{r} = min(dᵢ^{r})} |
| 20: | eᵢ ← Dist(tᵢ, rᵢ^{s}) |

| | |
|---|---|
| 21: | end for |
| 22: | eₜ^{rep} ← mean(eᵢ), ∀i ∈ tᵢ ∈ tₛ |

| | |
|---|---|
| 23: | end for |
| 24: | eₜ = mean(eₜ^{rep}), ∀rep ∈ nreps |

In other embodiments, a more sophisticated approach to map-matching can be used. For example, the Acc function used in the step/indicator B7) is formalized in the Equation (14).

$$Acc ( e ) = \{ \begin{matrix}1 , & if e < 15 \\ - \frac{3 ( e - 15 )}{100} + 1 , & if 15 < e \leq 35 \\ erfc ( e ) , & otherwise\end{matrix} \qquad ( 14 )$$

where the a parameter for the er f c is set to \sqrt{6}/6 (see Equation (11)).

In order to create a test bed to interpret and compare the results from the indicators according to an embodiment of the invention a data mining task was performed for Time Travel Prediction (TTP). The goal of TTP is to predict the duration of an ongoing trip. The final destination of a trip, which is associated with the remaining driving time, is predicted. This can be estimated by using information about the partial trajectory of a trip.

The predictive framework, based on an ensemble of experts, and the experimental setup was the same as in Proceedings of the ECML/PKDD 2015 Discovery Challenges co-located with European Conference on Machine Learning and Principles and Practice of Knowledge Discovery in Databases (ECML-PKDD 2015) <<http://ceur-ws.orgNo1-1526/>>, which is hereby incorporated herein by reference. The basic information used about each trip is the sequential geographic positions, as well as the corresponding timestamps. The position of the city center is also used to derive some attributions related to the positioning of the trip with respect to the downtown of the city.

As for preprocessing, trips with less than 4 GPS traces were excluded for numerical computation issues. However, very long trips, contrary to the suggestion in Proceedings of the ECML/PKDD 2015 Discovery Challenges co-located with European Conference on Machine Learning and Principles and Practice of Knowledge Discovery in Databases (ECML-PKDD 2015) <<http://ceur-ws.org/Vol-1526/>>, were not excluded. Since a goal is to compare how the same method for TTP works for different datasets in light of the indicators, any ad-hoc preprocessing more than strictly necessary is avoided to prevent a bias in the results. The current position of a vehicle was estimated by randomly cutting the full trajectories using a uniform distribution.

The performance of the method was estimated using the Root Mean Squared Error (RMSE), Root Mean Squared Logarithmic Error (RMSLE), Mean Absolute Deviation (MAD) and SMAPE on a 5-fold Cross Validation procedure. The results of the indicator set for each of the case studies is presented in Table III.

TABLE III
Indicator Results on the Case Studies

| Indicator | Nanjing | San Francisco |
|---|---|---|
| Granularity | 0.820 | 0.547 |
| Macro Temporal Coverage | 0.030 | 0.560 |
| Micro Temporal Coverage | 0.860 | 0.862 |
| Spatial Coverage | 0.653 | 0.318 |
| Missing Data | 0.615 | 0.658 |
| Reliability | 0.809 | 0.908 |

Embodiments of the present invention cover variations of the indicators and exemplary formulae, equations and algorithms, as well as:

(i) filtering in the source, assuming that the vehicles broadcast firstly their data to a central repository (e.g., taxi dispatching system; transit control system) and then are broadcast to the TMC. By doing the filtering in the same conditions on a filter-type of server located in each source repository, it would be expected to achieve the same type of technical results than with the proposed wrapper system, which is an exemplary embodiment of the invention. Such a system is an alternative exemplary wrapper-type of embodiment of the invention.

(ii) storing all the data and filtering it before performing step D2) real-time traffic status statistical estimation or DI short-term traffic status prediction using machine learning framework.

The present invention also applies to other types of data, which for the purposes of different embodiments of the invention constitute the FCD. For example, from a high-level perspective, FCD can be provided by any mobile source with capabilities of measuring the position of other moving actors (e.g., vehicles or persons) in real-time on a microscopic point of view (e.g., identifying each vehicle or person individually) and of broadcasting this information somehow. Examples of such alternatives would be mobile phones or drones equipped with video cameras.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method of filtering Floating Car Data (FCD) sources, the method comprising:
receiving data from the FCD sources;
computing, for each of the FCD sources, a plurality of indicators from the data received from the FCD sources, the indicators including at least one indicator that indicates a veracity of the data and at least one indicator that indicates a value of the data;
computing, for each of the FCD sources, a unified quality indicator from the respective indicators;
comparing the unified quality indicators to a predetermined threshold; and
storing the data received from the FCD sources excluding, based on the comparison, the data received from at least one of the FCD sources.

2. The method according to claim 1, wherein the at least one indicator that indicates the veracity of the data includes at least one of a missing data indicator, a reliability indicator or an accuracy indicator, and wherein the at least one indicator that indicates the value of the data includes at least one of a granularity indicator, a macro temporal coverage indicator, a micro temporal coverage indicator or a spatial coverage indicator.

3. The method according to clam 2, wherein the at least one indicator that indicates the value of the data includes at least the spatial coverage indicator.

4. The method according to claim 3, wherein the at least one indicator that indicates the value of the data includes each of the granularity indicator, a macro temporal coverage indicator, a micro temporal coverage indicator or a spatial coverage indicator

5. The method according to claim 1, wherein the at least one indicator that indicates the veracity of the data includes a missing data indicator, a reliability indicator and an accuracy indicator, and wherein the at least one indicator that indicates the value of the data includes a granularity indicator, a macro temporal coverage indicator, a micro temporal coverage indicator and a spatial coverage indicator.

6. The method according to claim 1, wherein each of the indicators output a continuous and normalized indicator value between 0 and 1, and wherein the unified quality indicator is calculated by a mean, a weighted average or a median of the indicator values.

7. The method according to claim 6, wherein the at least one indicator that indicates the value of the data includes at least a spatial coverage indicator, wherein the unified quality indicator is calculated by the weighted average, and wherein the spatial coverage indicator is weighted higher than the other indicators.

8. The method according to claim 6, wherein the unified quality indicator is calculated by the mean, and wherein at least one of the FCD sources having a lowest value for at least one of the indicators is penalized when taking the mean.

9. The method according to claim 1, further comprising:
outputting a current estimation of traffic status on a Geographic Area of Interest (GAOI) using the stored portion of the data; and
depicting the current estimation of the traffic status on a visualization tool.

10. The method according to claim 1, further comprising:
feeding the stored portion of the data to a machine learning/data mining framework;
outputting a future prediction of traffic status on a Geographic Area of Interest (GAOI); and
depicting the future prediction of the traffic status on a visualization tool.

11. A filter for use by a Traffic Management Center (TMC) to filter Floating Car Data (FCD) sources, the filter comprising one or more processors, which alone or in combination, are configured to:
receive data from the FCD sources;
compute, for each of the FCD sources, a plurality of indicators from the data received from the FCD sources, the indicators including at least one indicator that indicates a veracity of the data and at least one indicator that indicates a value of the data;
compute, for each of the FCD sources, a unified quality indicator from the respective indicators;
compare the unified quality indicators to a predetermined threshold; and
store the data received from the FCD sources excluding, based on the comparison, the data received from at least one of the FCD sources.

12. The filter according to claim 11, wherein the filter is configured to compute at least a spatial coverage indicator as the at least one indicator that indicates the value of the data.

13. The filter according to claim 11, wherein the filter is configured to compute each of the indicators as a continuous and normalized indicator value between 0 and 1, and is further configured to compute the unified quality indicator by a mean, a weighted average or a median of the indicator values.

14. A Traffic Management Center (TMC), comprising:
a filter for filtering Floating Car Data (FCD) sources, the filter comprising one or more processors, which alone or in combination, are configured to:
receive data from the FCD sources;
compute, for each of the FCD sources, a plurality of indicators from the data received from the FCD sources, the indicators including at least one indicator that indicates a veracity of the data and at least one indicator that indicates a value of the data;
compute, for each of the FCD sources, a unified quality indicator from the respective indicators;
compare the unified quality indicators to a predetermined threshold; and
store the data received from the FCD sources excluding, based on the comparison, the data received from at least one of the FCD sources, and
a memory containing only the portion of the data which the filter has stored.

15. The TMC according to claim 14, further comprising a visualization tool communicating with at least one of:
a traffic status server powered by a generic real-time status visualization analytics engine configured to output a current estimation of traffic status on a Geographic Area of Interest (GAOI) using the portion of the data stored in the memory and to provide the current estimation of the traffic status to the visualization tool; or
a future traffic status server powered by a data mining/machine learning future traffic status inference/prediction engine configured to output a future estimation of traffic status on the GAOI using the portion of the data stored in the memory and to provide the future estimation of the traffic status to the visualization tool.
